(19) United States
(12) Patent Application Publication
(10) Pub. No.: US 2026/0064636 A1
(43) Pub. Date: Mar. 5, 2026

(54) FOLDER ACTIVITY USER INTERFACE

(71) Applicant: Dropbox, Inc., San Francisco, CA (US)

(72) Inventor: Alex Garland, Bristol (GB)

(21) Appl. No.: 18/820,791

(22) Filed: Aug. 30, 2024

(51) Int. Cl. G06F 16/176; G06F 9/451

(52) U.S. Cl. CPC G06F 16/176; G06F 9/451

(57) ABSTRACT

Systems and methods for providing a folder activity user interface, such as a folder activity dashboard, that can provide viewing members with an overview of the sync progress of their own activities, like uploading content items, as well as the activities of other activity-initiating members, such as uploads to shared folders that the viewing members have access to. The folder activity user interface includes status indicators that correspond to the progress related to folder activity information and the respective content items of the shared folder, such as indicating progress towards when a respective content item will be accessible to the viewing member.

### BACKGROUND

Users sharing a shared folder of a content management system may often each upload various files to the shared folder, and such files may then be synced for the other users to view and access. In some cases, high volumes of large files may be required to be uploaded. Typically, users are able to see sync progress of their own uploads, so they are made aware of when the sync progresses are completed or if the sync had failed, and they have the option to re-sync.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a content management system and client devices in accordance with some aspects of the present technology.

FIG. 2 illustrates an example of a client synchronization service, in accordance with some aspects of the present technology.

FIG. 3 illustrates an example folder activity user interface, in accordance with some aspects of the present technology.

FIG. 4 illustrates an example notification tray, an aspect of the subject matter in accordance with some aspects of the present technology.

FIG. 5 illustrates an example client application interface displaying shared folder activity information in association with the respective content items, in accordance with some aspects of the present technology.

FIG. 6 illustrates an example method of providing a folder activity user interface to a viewing member of a shared folder, wherein the viewing member is different than an activity-initiating member that causes the folder activity, in accordance with some aspects of the present technology.

FIG. 7 illustrates an example of a computing system, in accordance with some aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Members of a shared folder of a content management system may each upload files to a shared folder. In some cases, the uploads may be a high volume of content items and/or large content items and one member may require a specific content item to complete its sync or upload before they can use it to work on a project, as an example. The specific content item may be in the process of being uploaded by another member of the shared folder or an external collaborator. The member may then uncertain of when they could reasonably expect to be able to work with the specific content item they are waiting on, and may not be able to plan their schedule with efficiency. These members may be team members of a large, distributed team, or another member of a shared folder that needs the specific content item. In either situation, the member that needs to know when the upload is likely to be complete would not want to ask other team members about when uploads may be completed, as it is not only inefficient but burdensome.

A folder activity user interface, such as a folder activity dashboard, can provide viewing members with an overview of the sync progress of their own activities, like uploading content items, as well as the activities of other activity-initiating members, such as uploads to shared folders that the viewing members have access to.

Additionally, the folder activity user interface may include status indicators that correspond to the progress related to folder activity information and the respective content items of the shared folder, such as indicating progress towards when a respective content item will be accessible to the viewing member. As such, the folder activity user interface may assist viewing members in determining when they can expect large operations, such as bulk uploads, to be completed, which can help them plan their days more efficiently. In some cases, the viewing members may subscribe to folder activity information by a sharing service, and receive a notification when a given upload has completed.

More specifically, the sharing service may receive an estimated time for the upload of a particular content item to the content management system from an uploading instance of a client application. The uploading instance of the client application may be a web browser or a client synchronization service. Additionally, the content management system or more specifically, the sharing service may provide the estimated time to the folder activity user interface.

In some cases, a total estimated time may combine (e.g., add) the estimated time for the content item to be uploaded to the content management system with an estimated time that the storage system of the content management system will take to store the content item and make it available to the client application. For example, it may take a certain amount of time for the upload and another amount of time to store and have the content item be available at the client application.

The folder activity user interface can also include a sync priority user interface control that can be used to prioritize one content item over others. An indication of a selection of the sync priority user interface control may be received and be effective to cause an activity-initiating member instance of the client application to prioritize uploading a particular content item from the one or more currently uploading content items. For example, one particular content item of a batch of content items that are being uploaded may be prioritized by the selection of a sync priority user interface control associated with the particular content item. This prioritization of the particular content item might have side effects that make synchronization of the user account less efficient overall. For example, the prioritization may effectively mean prioritize syncing of at least metadata for a branch of a file tree, cause the client synchronization service to be less efficient by prioritizing the particular content item, or synchronize the particular content item down first even if the location is not correct and the content item can be moved after syncing is completed.

In some cases, the viewing member may be automatically subscribed to receive folder activity information for all shared folders to which the viewing member has access. For example, the sharing service or content management system may determine, based at least on a heuristic (such as a folder activity subscription heuristic) or a machine learning model, to automatically subscribe the viewing member to receive the shared folder activity information for the shared folder in the folder activity user interface. The content management system may determine to automatically subscribe the viewing member to receive the shared folder activity information for the shared folder in the folder activity user interface, and cause the viewing member to be subscribed to the shared folder activity information temporarily. In some cases, the viewing member may become unsubscribed after the shared folder has completed synchronization for the viewing member, or become unsubscribed after a pre-determined period.

The determination to automatically subscribe may account for whether the viewing member is active in the shared folder, wherein the viewing member is determined to be active in the shared folder when they access a content item in the shared folder more often a predetermined metric. The predetermined metric can be that they access the content item more often than (e.g., once a month, once a week, twice a week, every day, multiple times a day . . . ). The determination to automatically subscribe may account for whether the viewing member created the shared folder, and/or whether the content items being uploaded will take greater than a threshold amount of time to upload (e.g., the one or more content items will take more than 5 seconds, 15 seconds, 30 seconds, 1 minute, etc.).

In some cases, the sharing service may receive a request from the activity-initiating member to subscribe the viewing member to the shared folder activity information for the shared folder. The request from the activity-initiating member to subscribe the viewing member to the shared folder activity information may be received in a sharing modal in which the activity-initiating member shares the shared folder with the viewing member. The sharing modal may provide other types of sharing notifications as well. The request from the activity-initiating member to subscribe the viewing member to the shared folder activity information may be request to a prompt provided to the activity-initiating member instance of the client application when the activity-initiating member adds a large number of content items to the shared folder, or adds a large content item to the shared folder. In some cases, the large number is determined to be over a threshold limit or a size over a threshold limit. The prompt may ask the activity-initiating member if they want to subscribe the viewing member to the shared folder activity information.

In some cases, a web browser instance of the client application may present a pop-up window when the viewing member is viewing a content item in the shared folder or viewing a listing of contents under the shared folder in the web browser instance of the client application. The content items being uploaded make take greater than a threshold amount of time to upload (e.g., the one or more content items will take more than 5 seconds, 15 seconds, 30 seconds, 1 minute, etc.). An input requesting the client application to present the folder activity user interface may be received, and the input may request the client application to present the folder activity user interface is received in the pop-up window. In some cases, the content management system may provide the necessary content to display such pop-up windows at the client application.

In some cases, the web browser instance of the client application may present a file explorer interface showing a folder hierarchy for the viewing member account with a status indicator showing upload activity in the at least one shared folder, wherein the input requesting the client application to present the folder activity user interface is received through a selection of the status indicator. In some cases, the content management system may provide the necessary content to display the folder hierarchy at the client application.

In some cases, a desktop instance of the client application on a client device may present a file explorer showing a path to the shared folder and a progress bar indicating the estimated time remaining for currently uploading content items in the shared folder. Selecting the progress bar may reveal additional information (such as in a pop-up window) about the sync status, such as a list of items in the selected folder and the remaining time required for upload. The content items being uploaded may take greater than a threshold amount of time to upload (e.g., the one or more content items will take more than 5 seconds, 15 seconds, 30 seconds, 1 minute, etc.). The input requesting the client application to present the folder activity user interface may be received in the pop-up window. In some cases, the content management system may provide the necessary content to display the file explorer at the client application.

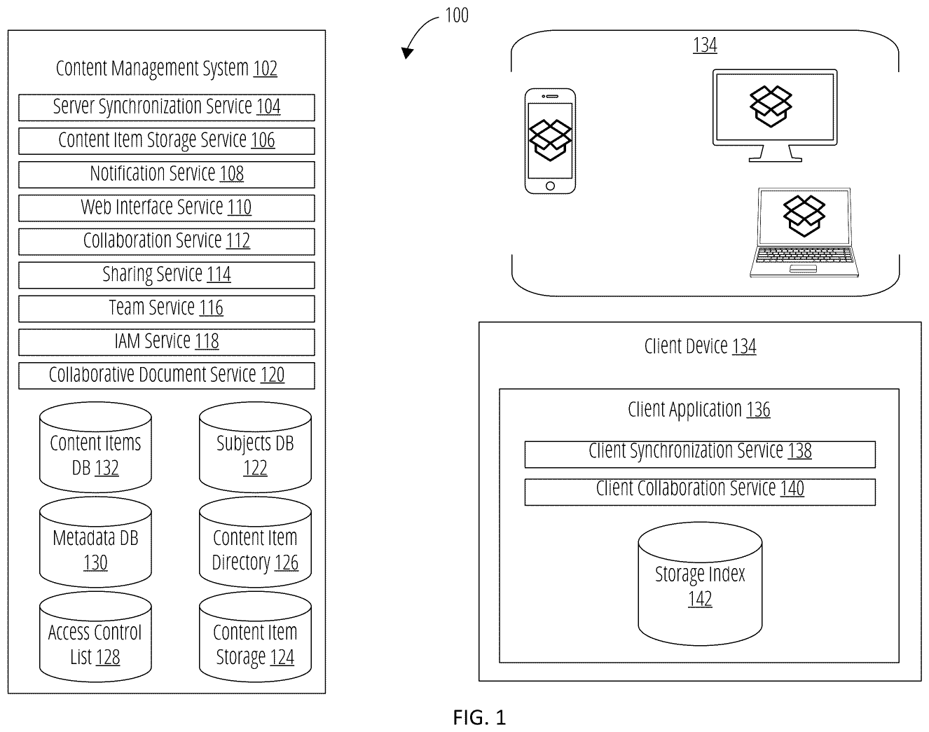

In some embodiments the disclosed technology is deployed in the context of a content management system having content item synchronization capabilities and collaboration features, among others. An example system configuration 100 is shown in FIG. 1, which depicts content management system 102 interacting with client device 134.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Accounts

Content management system 102 can store content items in association with accounts, as well as perform a variety of content item management tasks, such as retrieve, modify, browse, and/or share the content item(s). Furthermore, content management system 102 can enable an account to access content item(s) from multiple client devices.

Content management system 102 supports a plurality of accounts. A subject (user, group, team, company, etc.) can create an account with content management system, and account details can be stored in subject database 122. Subject database 122 can identify a registered subject by a subject ID, and store profile information for registered subjects in association with the subject ID. In some cases, profile information for registered subjects includes a subject name and/or email address. Subject database 122 can include account management information, such as account type (e.g. various tiers of free or paid accounts), storage space allocated, storage space used, client devices 134 having a registered content management client application 136 resident thereon, security settings, personal configuration settings, etc. In some embodiments, some information associated with an account may not be directly stored, and rather this information can be derived. For example, storage space used might be explicitly stored, or it can be calculated when needed.

In some embodiments, subject database 122 need not store complete information associated with an account for a subject. Some portion of information associated with an account for a subject can also be stored in another database of content management system 102 such as metadata database 130, or in a database external to content management system 102.

Subject database 122 can store groups of accounts associated with a subject. Groups can have permissions based on group permissions statements and/or access control lists, and members of the groups can inherit the permissions. For example, a marketing group can have access to one set of content items while an engineering group can have access to another set of content items. An administrator group can modify groups, modify subject accounts, etc. Groups are also subjects identified by subject ID.

In some embodiments, subject database 122 can be broken into a plurality of tables, indexes and other data structures.

### Content Item Storage

A feature of content management system 102 is the storage of content items, which can be stored in content item storage 124. An object generally is any entity that can be recorded in a file system. Objects can be any object including digital data such as documents, collaboration objects, text files, audio files, image files, video files, webpages, executable files, binary files, content item directories, folders, zip files, playlists, albums, symlinks, cloud docs, mounts, placeholder objects referencing other objects in content management system 102 or in other content management systems, etc.

In some embodiments, content items can be grouped into a collection, which can refer to a folder including a plurality of content items, or a plurality of content items that are related or grouped by a common attribute.

In some embodiments, content item storage 124 is combined with other types of storage or databases to handle specific functions. Content item storage 124 can store objects, while metadata regarding the objects can be stored in metadata database 130. Likewise, data regarding where an object is stored in content item storage 124 can be stored in content item directory 126. Additionally, data regarding changes, access, etc. can be stored in content items database 132. Content items database 132 can also include a subject account identifier that identifies the subject IDs that have access to the object.

In some embodiments, content items database 132 can be broken into a plurality of tables, indexes and other data structures.

Each of the various storages/databases such as content item storage 124, content item directory 126, content items database 132, and metadata database 130 can be comprised of more than one such storage or database and can be distributed over many devices and locations. Other configurations are also possible. For example, data from content item storage 124, content item directory 126, content items database 132, and/or metadata database 130 may be combined into one or more content item storages or databases or further segmented into additional content item storages or databases. Thus, content management system 102 may include more or less storages and/or databases than shown in FIG. 1.

In some embodiments, content item storage 124 is associated with at least one content item storage service 106, which includes software or other processor executable instructions for managing the storage of content items including, but not limited to, receiving content items for storage, preparing content items for storage, selecting a storage location for the content item, retrieving content items from storage, etc. In some embodiments, content item storage service 106 can divide an object into smaller chunks for storage at content item storage 124. The location of each chunk making up an object can be recorded in content item directory 126. Content item directory 126 can include a content entry for each object stored in content item storage 124. The content entry can be associated with an object ID, which uniquely identifies an object.

In some embodiments, each content item and each chunk of a content item can also be identified from a deterministic hash function. This method of identifying a content item and chunks of content items can ensure that content item duplicates are recognized as such since the deterministic hash function will output the same hash for every copy of the same content item, but will output a different hash for a different content item. Using this methodology, content item storage service 106 can output a unique hash for each different version of an object.

Content item storage service 106 can also designate or record a parent of a content item or a content path for a content item in content items database 132. The content path can include the name of the object and/or folder hierarchy associated with the object. For example, the content path can include a folder or path of folders in which the object is stored in a local file system on a client device. In some embodiments, content item database might only store a direct ancestor or direct child of any object, which allows a full path for an object to be derived, and can be more efficient than storing the whole path for an object.

While content items are stored in content item storage 124 in blocks and may not be stored under a tree like directory structure, such directory structure is a comfortable navigation structure for subjects viewing content items. Content item storage service 106 can define or record a content path for an object wherein the “root” node of a directory structure can be any directory with specific access privileges assigned to it, as opposed to a directory that inherits access privileges from another directory.

In some embodiments a root directory can be mounted underneath another root directory to give the appearance of a single directory structure. This can occur when an account has access to a plurality of root directories. As addressed above, the directory structure is merely a comfortable navigation structure for subjects viewing objects, but does not correlate to storage locations of objects in content item storage 124.

While the directory structure in which an account views content items does not correlate to storage locations of the content items at content management system 102, the directory structure can correlate to storage locations of the content items on client device 134 depending on the file system used by client device 134.

As addressed above, a content entry in content item directory 126 can also include the location of each chunk making up a content item. More specifically, the content entry can include content pointers that identify the location in content item storage 124 of the chunks that make up the object.

Content item storage service 106 can decrease the amount of storage space required by identifying duplicate content items or duplicate blocks that make up a content item or versions of a content item. Instead of storing multiple copies, content item storage 124 can store a single copy of the content item or block of the content item, and content item directory 126 can include a pointer or other mechanism to link the duplicates to the single copy.

Content item storage service 106 can also store metadata describing content items, content item types, folders, file path, and/or the relationship of content items to various accounts, collections, or groups in metadata database 130, in association with the content item ID of the content item.

Content item storage service 106 can also store a log of data regarding changes, access, etc. in content items database 132. Content items database 132 can include the object ID of the object and can optionally include a description of the change or access action along with a time stamp or version number and any other relevant data. Content items database 132 can also include pointers to blocks affected by the change or object access. Content item storage service 106 can also provide the ability to undo operations, by using an object version control mechanism that tracks changes to objects, different versions of objects (including diverging version trees), and a change history that can be acquired from content items database 132.

### Content Item Synchronization

Another feature of content management system 102 is synchronization of content items with at least one client device 134. Client devices 134 can take different forms and have different capabilities. For example, client device 134 can be a computing device having a local file system accessible by multiple applications resident thereon. Client device 134 can be a computing device wherein objects are only accessible to a specific application or by permission given by the specific application, and the objects are typically stored either in an application specific space or in the cloud. Client device 134 can be any client device accessing content management system 102 via a web browser and accessing objects via a web interface. While example client device 134 is depicted in form factors such as a laptop, mobile device, or web browser, it should be understood that the descriptions thereof are not limited to devices of these example form factors. For example, a mobile device might have a local file system accessible by multiple applications resident thereon, or might access content management system 102 via a web browser. As such, the form factor should not be considered limiting when considering client device 134's capabilities. One or more functions described herein with respect to client device 134 may or may not be available on every client device depending on the specific capabilities of the device-the file access model being one such capability.

In many embodiments, client devices 134 are associated with an account of content management system 102, but in some embodiments client device 134 can access content using shared links and do not require an account.

As noted above, some client devices can access content management system 102 using a web browser. However, client devices can also access content management system 102 using client application 136 stored and running on client device 134. Client application 136 can include a client synchronization service 138.

Client synchronization service 138 can be in communication with server synchronization service 104 to synchronize changes to content items between client device 134 and content management system 102.

Client device 134 can synchronize content with content management system 102 via client synchronization service 138. The synchronization can be platform agnostic. That is, content can be synchronized across multiple client devices of varying types, capabilities, operating systems, etc. Client synchronization service 138 can synchronize any changes (e.g., new, deleted, modified, copied, or moved content items) to content items in a designated location of a file system of client device 134.

Content items can be synchronized from client device 134 to content management system 102, and vice versa. In embodiments wherein synchronization is from client device 134 to content management system 102, a subject can manipulate objects directly from the file system of client device 134, while client synchronization service 138 can monitor directory on client device 134 for changes to files within the monitored folders.

When client synchronization service 138 detects a write, move, copy, or delete of content in a directory that it monitors, client synchronization service 138 can synchronize the changes to content item storage service 106. In some embodiments, client synchronization service 138 can perform some functions of content item storage service 106 including functions addressed above such as dividing the object into blocks, hashing the object to generate a unique identifier, etc. Client synchronization service 138 can index content within client storage index 142 and save the result in client storage index 142. Indexing can include storing paths plus the object identifier, and a unique identifier for each object. In some embodiments, client synchronization service 138 learns the object identifier from server synchronization service 104, and learns the unique client identifier from the operating system of client device 134.

Client synchronization service 138 can use storage index 142 to facilitate the synchronization of at least a portion of the content items within client storage with content items associated with a subject account on content management system 102. For example, client synchronization service 138 can compare storage index 142 with content management system 102 and detect differences between content on client storage and content associated with a subject account on content management system 102. Client synchronization service 138 can then attempt to reconcile differences by uploading, downloading, modifying, and deleting content on client storage as appropriate. Content item storage service 106 can store the changed or new block for the object and update content items database 132, metadata database 130, content item directory 126, content item storage 124, subject database 122, etc. as appropriate.

When synchronizing from content management system 102 to client device 134, data regarding a mount, modification, addition, deletion, move of a content item recorded in content items database 132 can trigger a notification to be sent to client device 134 using notification service 108. When client device 134 is informed of the change, client device 134 can make a request for changes listed in content items database 132 since the last synchronization point known to the client device. When client device 134 determines that it is out of synchronization with content management system 102, client synchronization service 138 requests object blocks including the changes, and updates its local copy of the changed objects.

In some embodiments, storage index 142 stores tree data structures wherein one tree reflects the latest representation of a directory according to server synchronization service 104, while another tree reflects the latest representation of the directory according to client synchronization service 138. Client synchronization service 138 can work to ensure that the tree structures match by requesting data from server synchronization service 104 or committing changes on client device 134 to content management system 102.

Sometimes client device 134 might not have a network connection available. In this scenario, client synchronization service 138 can monitor the linked collection for content item changes and queue those changes for later synchronization to content management system 102 when a network connection is available. Similarly, a subject can manually start, stop, pause, or resume synchronization with content management system 102.

Client synchronization service 138 can synchronize all content associated with a particular subject account on content management system 102. Alternatively, client synchronization service 138 can selectively synchronize some of the content items associated with the particular subject account on content management system 102. Selectively synchronizing only some of the content items can preserve space on client device 134 and save bandwidth.

In some embodiments, client synchronization service 138 selectively stores a portion of the content items associated with the particular subject account and stores placeholder content items in client storage for the remainder portion of the content items. For example, client synchronization service 138 can store a placeholder content item that has the same filename, path, extension, metadata, of its respective complete content item on content management system 102, but lacking the data of the complete content item. The placeholder content item can be a few bytes or less in size while the respective complete content item might be significantly larger. After client device 134 attempts to access the content item, client synchronization service 138 can retrieve the data of the content item from content management system 102 and provide the complete content item to client device 134. This approach can provide significant space and bandwidth savings while still providing full access to a subject's content items on content management system 102.

While the synchronization embodiments addressed above referred to client device 134 and a server of content management system 102, it should be appreciated by those of ordinary skill in the art that a user account can have any number of client devices 134 all synchronizing content items with content management system 102, such that changes to a content item on any one client device 134 can propagate to other client devices 134 through their respective synchronization with content management system 102.

### Collaboration Features

Another feature of content management system 102 is to facilitate collaboration between subjects. Collaboration features include content item sharing, commenting on content items, co-working on content items in real time, instant messaging, providing presence and “seen” state information regarding content items, etc.

### Sharing

Content management system 102 can manage sharing content items via sharing service 114. Sharing a content item by providing a link to the content item can include making the content item accessible from any computing device in network communication with content management system 102. However, in some embodiments a link can be associated with access restrictions enforced by content management system 102 and Identity and Access Management service (IAM service) 118. Sharing content can also include linking content using sharing service 114 to share content within content management system 102 with at least one additional subject account (in addition to the original subject account associated with the object) so that each subject account has access to the object. The additional subject account can gain access to the content by accepting the content, which will then be accessible through either web interface service 110 or directly from within the directory structure associated with their account on client device 134. The sharing can be performed in a platform agnostic manner. That is, the content can be shared across multiple client devices 134 of varying type, capabilities, operating systems, etc. The content can also be shared across varying types of subject accounts.

To share a content item within content management system 102, sharing service 114 can add associate a subject ID of a team or of one or more subject accounts with a content item in content items database 132 associated with the content item, thus granting the added subject account(s) access to the content item. Sharing service 114 can also remove subject IDs from being permitted to access a content item in content items database 132 to restrict a subject account's access to the content item. Sharing service 114 can record object identifiers, subject identifiers given access to an object, and access levels in content items database 132. For example, in some embodiments, subject identifiers associated with a single content item can specify different permissions for respective subject identifiers with respect to the associated object.

In some embodiments, content management system 102 can include an access control list 128 which includes a description of complete access rights pertaining to a respective content item. An access control list for any respective object in content management system can be derived from content items database 132. In some embodiments, it is not desirable to maintain a persistent access control list 128 for a respective object, as an access control list 128 for a respective object can be derived when needed. In some embodiments, objects can inherit access rights from another object such as ancestor objects.

To share content items outside of content management system 102, sharing service 114 can generate a custom network address, such as a uniform resource locator (URL), which allows any web browser to access the content item or collection in content management system 102 without any authentication. To accomplish this, sharing service 114 can include content identification data in the generated URL, which can later be used to properly identify and return the requested content item. For example, sharing service 114 can include a token identifying a content item ID and optionally a subject ID in the generated URL. Upon selection of the URL, the content identification data included in the URL can be transmitted to content management system 102, which can use the received content identification data to identify the appropriate content item and return the content item.

In addition to generating the URL, sharing service 114 can also be configured to record in content items database 132 that a URL to the content item has been created. In some embodiments, an entry into content items database 132 associated with a content item can include a URL flag indicating whether a URL to the content item has been created. For example, the URL flag can be a Boolean value initially set to 0 or false to indicate that a URL to the content item has not been created. Sharing service 114 can change the value of the flag to 1 or true after generating a URL to the content item.

In some embodiments, sharing service 114 can associate a set of permissions to a URL for a content item. For example, if a subject attempts to access the content item via the URL, sharing service 114 can provide a limited set of permissions for the content item. Examples of limited permissions include restrictions that the subject cannot download the content item, save the content item, copy the content item, modify the content item, etc. In some embodiments, limited permissions include restrictions that only permit an object to be accessed from with a specified domain, i.e., from within a corporate network domain, or by accounts associated with a specified domain, e.g., accounts associated with a company account (e.g., @acme.com).

In some embodiments, sharing service 114 can also be configured to deactivate a generated URL. For example, each entry into content items database 132 can also include a URL active flag indicating whether the content should be returned in response to a request from the generated URL. For example, sharing service 114 can only return a content item requested by a generated link if the URL active flag is set to 1 or true. Thus, access to a content item for which a URL has been generated can be easily restricted by changing the value of the URL active flag. This allows a subject to restrict access to the shared content item without having to move the content item or delete the generated URL. Likewise, sharing service 114 can reactivate the URL by again changing the value of the URL active flag to 1 or true. A subject can thus easily restore access to the content item without the need to generate a new URL.

In some embodiments, content management system 102 can designate a URL for uploading a content item. For example, a first subject with a subject account can request such a URL, provide the URL to a contributing subject and the contributing subject can upload a content item to the first subject's subject account using the URL.

### Team Service

In some embodiments content management system 102 includes team service 116. Team service 116 can provide functionality for creating and managing defined teams of subject accounts. Teams can be created for a company, with sub-teams (e.g., business units, or project teams, etc.), and subject accounts assigned to teams and sub-teams, or teams can be created for any defined group of subject accounts. Team service 116 can provide a common shared space for the team, private subject account folders, and access limited shared folders. Team service 116 can also provide a management interface for an administrator to manage collections and objects within team, and can manage subject accounts that are associated with the team. Teams, sub-teams, subject accounts are all given a subject identifier in subject database 122, and the membership to teams by subject accounts is also recorded in subject database 122.

### IAM (Identity and Access Management) Service

In some embodiments, content management system 102 includes IAM service 118. IAM service 118 can authenticate a subject account. For subject accounts with multiple levels of rights (e.g. a subject account with subject rights and administrator rights) IAM service 118 can also facilitate explicit privilege escalation to avoid unintentional actions by administrators.

### Content Item Access

Content item storage service 106 can receive a token from client application 136 that follows a request to access a content item and can return the capabilities permitted to the subject account.

### Presence and Seen State

In some embodiments, content management system 102 can provide information about how subjects with which a content item is shared are interacting or have interacted with the content item. In some embodiments, content management system 102 can report that a subject with which an object is shared is currently viewing the object. For example, client collaboration service 140 can notify notification service 108 when client device 134 is accessing the object. Notification service 108 can then notify all client devices of other subjects having access to the same object of the presence of the subject of client device 134 with respect to the object.

In some embodiments, content management system 102 can report a history of subject interaction with a shared content item. Collaboration service 112 can query data sources such as metadata database 130 and content items database 132 to determine that a subject has saved the content item, that a subject has yet to view the content item, etc., and disseminate this status information using notification service 108 to other subjects so that they can know who currently is or has viewed or modified the content item.

Collaboration service 112 can facilitate comments associated with content, even if a content item does not natively support commenting functionality. Such comments can be stored in metadata database 130.

Collaboration service 112 can originate and transmit notifications for subjects. For example, a subject can mention another subject in a comment and collaboration service 112 can send a notification to that subject letting them know that they have been mentioned in the comment. Various other content item events can trigger notifications, including deleting a content item, sharing a content item, etc.

Collaboration service 112 can also provide a messaging platform whereby subjects can send and receive instant messages, voice calls, emails, etc.

### Collaboration Content items

In some embodiments content management service can also include collaborative document service 120 which can provide an interactive content item collaboration platform whereby subjects can simultaneously create collaboration content items, comment in the collaboration content items, and manage tasks within the collaboration content items. Collaboration content items can be files that subjects can create and edit using a collaboration content item editor, and can contain collaboration content item elements. Collaboration object elements may include a collaboration object identifier, one or more author identifiers, collaboration object text, collaboration object attributes, interaction information, comments, sharing subjects, etc. Collaboration object elements can be stored as database entities, which allows for searching and retrieving the collaboration objects. Multiple subjects may access, view, edit, and collaborate on collaboration objects at the same time or at different times. In some embodiments this can be managed by requiring two subjects access an object through a web interface and there they can work on the same copy of the object at the same time.

### Collaboration Companion Interface

In some embodiments client collaboration service 140 can provide a native application companion interface for the purpose of displaying information relevant to a content item being presented on client device 134. In embodiments wherein a content item is accessed by a native application stored and executed on client device 134, where the content item is in a designated location of the file system of client device 134 such that the content item is managed by client application 136, the native application may not provide any native way to display the above addressed collaboration data. In such embodiments, client collaboration service 140 can detect that a subject has opened an object, and can provide an overlay with additional information for the object, such as collaboration data. For example, the additional information can include comments for the object, status of the object, activity of other subjects previously or currently viewing the object. Such an overlay can warn a subject that changes might be lost because another subject is currently editing the object.

In some embodiments, one or more of the services or storages/databases discussed above can be accessed using public or private application programming interfaces.

Certain software applications can access content item storage 124 via an API on behalf of a subject. For example, a software package such as an application running on client device 134, can programmatically make API calls directly to content management system 102 when a subject provides authentication credentials, to read, write, create, delete, share, or otherwise manipulate content.

A subject can view or manipulate content stored in a subject account via a web interface generated and served by web interface service 110. For example, the subject can navigate in a web browser to a web address provided by content management system 102. Changes or updates to content in the content item storage 124 made through the web interface, such as uploading a new version of a content item, can be propagated back to other client devices associated with the subject's account. For example, multiple client devices, each with their own client software, can be associated with a single account and content items in the account can be synchronized between each of the multiple client devices.

Client device 134 can connect to content management system 102 on behalf of a subject. A subject can directly interact with client device 134, for example when client device 134 is a desktop or laptop computer, phone, television, internet-of-things device, etc. Alternatively or additionally, client device 134 can act on behalf of the subject without the subject having physical access to client device 134, for example when client device 134 is a server.

Some features of client device 134 are enabled by an application installed on client device 134. In some embodiments, the application can include a content management system specific component. For example, the content management system specific component can be a stand-alone client application 136, one or more application plug-ins, and/or a browser extension. However, the subject can also interact with content management system 102 via a third-party application, such as a web browser, that resides on client device 134 and is configured to communicate with content management system 102. In various implementations, the client application 136 can present a subject interface (UI) for a subject to interact with content management system 102. For example, the subject can interact with the content management system 102 via a file system explorer integrated with the file system or via a webpage displayed using a web browser application.

In some embodiments, client application 136 can be configured to manage and synchronize content for more than one account of content management system 102. In such embodiments client application 136 can remain logged into multiple accounts and provide normal services for the multiple accounts. In some embodiments, each account can appear as folder in a file system, and all objects within that folder can be synchronized with content management system 102. In some embodiments, client application 136 can include a selector to choose one of the multiple accounts to be the primary account or default account.

### Third Party Services

In some embodiments content management system 102 can include functionality to interface with one or more third party services such as workspace services, email services, task services, etc. In such embodiments, content management system 102 can be provided with login credentials for a subject account at the third party service to interact with the third party service to bring functionality or data from those third party services into various subject interfaces provided by content management system 102.

While content management system 102 is presented with specific components, it should be understood by one skilled in the art, that the architectural system configuration 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural system configuration 100 is simply one possible configuration and that other configurations with more or fewer components are possible.

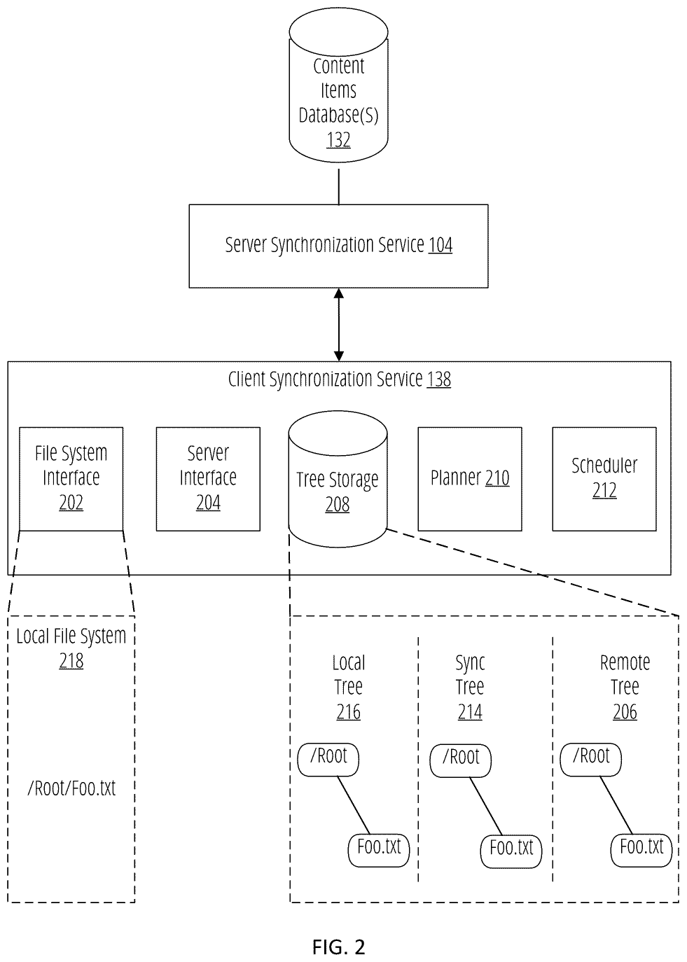

FIG. 2 shows an example of a client synchronization service 138, in accordance with some embodiments. Client synchronization service 138 may be implemented in the client device 134 of FIG. 1. However, in some embodiments, client synchronization service 138 may be implemented on another computing device. Client synchronization service 138 is configured to synchronize changes to objects between content management system 102 and the client device 134 on which client synchronization service 138 runs.

Client synchronization service 138 may include file system interface 202, server interface 204, tree storage 208, planner 210, and scheduler 212. Additional or alternative components may also be included.

File system interface 202 is configured to process changes to content items on local file system 218 of client device 134 and update local tree 216 or to make changes to local file system 218. For example, file system interface 202 can detect changes to objects on local file system 218 of client device 134. Changes may also be made and detected via client application 136 of FIG. 1. File system interface 202 may make updates to local tree 216. The updates to local tree 216 may be made based on the changes (new, deleted, modified, copied, renamed, or moved objects) to objects on the client device.

Server interface 204 is configured to aid in the processing of remote changes to content items at content management system 102 and updating of remote tree 206. For example, server interface 204 can be in communication with server synchronization service 104 to synchronize changes to objects between client device 134 and content management system 102. Changes (new, deleted, modified, copied, renamed, or moved objects) to objects at content management system 102 may be detected and updates may be made to remote tree 206 to reflect the changes at content management system 102. Server interface 204 is also configured to aid in the communicating of local changes to objects at local file system 218 to server synchronization service 104 to update content items database 132.

Tree storage 208 is configured to store and maintain the tree data structures used by client synchronization service 138. For example, tree storage 208 may store local tree 216, sync tree 214, and remote tree 206. In some embodiments, tree storage 208 may store the tree data structures in persistent memory (e.g., a hard disk or other secondary storage device) as well as in main memory (e.g., RAM or other primary storage device) in order to reduce latency and response time. For example, on start-up of the client device or client synchronization service 138, the tree data structures may be retrieved from persistent memory and loaded into main memory. Tree storage 208 may access and update the tree data structures on main memory and, before the client device 134 or client synchronization service 138 is shut down, tree storage 208 may store the updated tree data structures in persistent memory.

Remote tree 206 represents a server state or the state of objects stored remotely from the client device (e.g., on a server of the content management system 102). Local tree 216 represents a file system state or the state of the corresponding objects stored locally on the client device. Sync tree 214 represents a merge base for the local tree and the remote tree. The merge base may be thought of as a common ancestor of the local tree and the remote tree or a last known synced state between the local tree and the remote tree.

Each tree data structure (e.g., remote tree 206, sync tree 214, or local tree 216) may include one or more nodes. Each node in a tree data structure may represent an object (e.g., a file, document, folder, etc.). Each node in a tree data structure may contain data such as, for example, a directory object identifier specifying the object identifier of a parent node of the object, an object name for the object, an object identifier for the object, and metadata for the object.

Planner 210 is configured to detect differences between the server state associated with content management system 102 and the file system state associated with the client device 134 based on the state of the tree data structures. For example, planner 210 may determine if there is a difference between remote tree 206 and sync tree 214. A difference between remote tree 206 and sync tree 214 indicates that an action performed remotely on one or more objects stored at content management system 102 has caused the server state and the file system state to become out of sync. Similarly, planner 210 may also determine if there is a difference between local tree 216 and the sync tree 214. A difference between local tree 216 and sync tree 214 indicates that an action performed locally on one or more objects stored in local file system 218 on client device 134 has caused the server state and the file system state to become out of sync. If a difference is detected, planner 210 generates a set of operations that synchronize the tree data structures.

In some scenarios, a set of operations generated based on a difference between the remote tree and the sync tree and a set of operations generated based on a difference between the local tree and the sync tree may conflict. Planner 210 may also be configured to merge the two sets of operations into a single merged plan of operations.

Scheduler 212 is configured to take the generated plan of operations and manage the execution of those operations. According to some embodiments, scheduler 212 converts each operation in the plan of operations into a series of one or more tasks that need to be executed in order to perform the operation. In some scenarios, some tasks may become out dated or no longer relevant. Scheduler 212 is configured to identify those tasks and cancel them.

When a difference exists between local tree 216 and sync tree 214, a change needs to be synchronized to content management system 102. To synchronize a change in local file system 218 to content management system 102, client synchronization service can commit an intent to server synchronization service 104 pertaining to specific synchronization operations. To commit the intent, client synchronization service 138 on client device 134 records an intent to commit an operation at client device 134. Client synchronization service 138 can record the intent to commit the operation durably on disk or memory at client device 134 to track the pending commit. Client device 134 can store dirty commit records and track modifications until an event triggers removal of the pending commit(s), such as a failure or success. Client synchronization service 138 also commits the operation to server synchronization service 104 by sending a message to server synchronization service 104 requesting to commit the operation.

Server synchronization service 104 can send a return message indicating whether the commit to content management system 102 succeeded or indicating an error. Only once client synchronization service 138 learns that the commit succeeded will client synchronization service 138 update remote tree 206 and sync tree 214 to include the synchronized operation and clear the intent to commit the operation from client device 134.

Client application 136 can learn of a change existing at a server by requesting information regarding events occurring on content items recorded in content items database 132 since a last synchronization time known to the client device 134. In some embodiments, client synchronization service 138 makes a request for updated information periodically, or in response to receiving notifications about possible changes. When a change has occurred in the account at the content management system, server synchronization service 104 can send information about the operation that was performed to client synchronization service 138 which can update remote tree 206. Thereafter, client synchronization service 138 can detect a difference between remote tree 206 and sync tree 214 indicating that local file system 218 needs to be updated. Planner 210 can identify operations needed to update local file system 218, and server interface 204 can request any data, such as blocks making up objects, etc. from content management system 102.

Client synchronization service 138 can update local file system 218, local tree 216, and sync tree 214 to bring the system into a synchronized state. Additionally, client synchronization service 138 can store information identifying the synchronization time pertaining to the information received from content items database 132 to indicate that client application is up to date to at least the last synchronization time. In some embodiments, the last synchronization time pertains to a row in content items database 132, and can be stored as part of a cryptographically signed cursor that is received from content management system 102. The next time client synchronization service requests updated information, it will supply the cursor to identify a point in content items database 132 from which to begin reading.

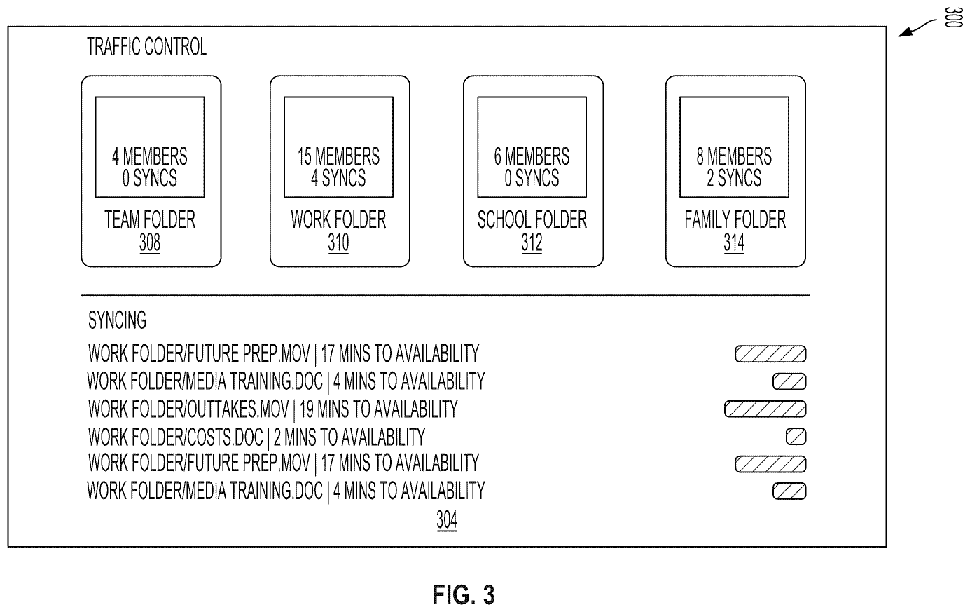

FIG. 3 illustrates an example folder activity user interface, in accordance with some aspects of the present technology.

The example folder activity user interface 300, presents a folder activity dashboard under a “traffic control” title, may show the various folders that a viewing member is subscribed to. For each subscribed folder, an overview for each may be provided, such that a number of syncs associated with each folder may be presented. As shown in FIG. 3, for example, the viewing member is subscribed to at least four folders, a team folder 308, a work folder 310, a school folder 312, and a family folder 314. For these folders, the folder activity user interface 300 shows some features associated therewith. For example, the folder activity user interface 300 shows the number of members sharing each folder and the number of presently syncing content items. The folder activity user interface 300 may also show all the presently syncing content items from all of the subscribed folders in one view, and an estimate of how long before the respective content items will be available. There is also a sync priority user interface control button for the presently syncing content items.

Additionally, the folder activity user interface 300 may present folder activity associated with the viewing member's own syncing activities.

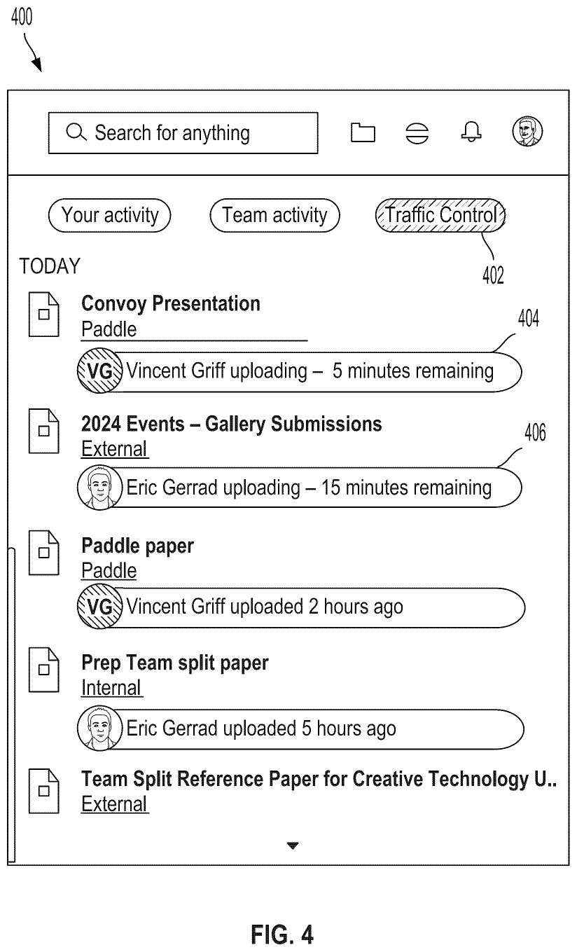

FIG. 4 illustrates an example notification tray, in accordance with some aspects of the present technology.

The example notifications tray 400 includes another version of a folder activity user interface (under a “traffic control” tab 402), which is a condensed version of the full folder activity user interface 300. The notifications tray 400 includes a most recent history of content items currently being uploaded and their status of upload along with the history of recently successfully uploaded content items. For example, the “Convoy Presentation” that is being uploaded by Vincent, a different user than the user associated with the notifications tray 400, may still have an estimate of 5 minutes remaining. As another example, “2024 Events—Gallery Submissions” may be associated with a plurality of content items that are being uploaded, and the 15 minutes remaining may be based on an estimate of the content items that are associated with that upload.

The notifications tray 400 may provide access to the full folder activity user interface 300 to allow the user to launch the full interface via a web browser (or a modal, which is a view of a web interface presented by the desktop client). The notifications tray 400 may show all the presently syncing content items from all of the subscribed folders in one view, and an estimate of how long before they will be available. There may also a sync priority user interface control button for each of the presently syncing content items.

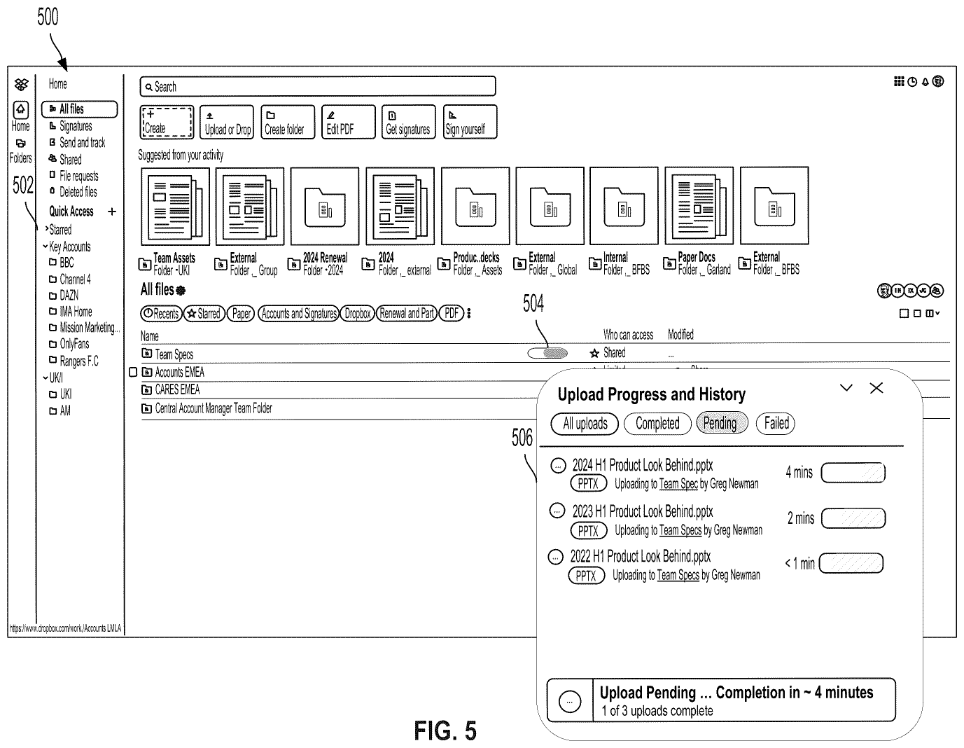

FIG. 5 illustrates an example client application interface displaying shared folder activity information in association with the respective content items, in accordance with some aspects of the present technology.

The example client application interface 500, which may be a web interface, includes a directory tree interface 502 that displays the content items of a particular folder in view. Next to any content item or folder associated with sync activity may be a progress bar 504 showing how long it is estimated to sync the content item or content items in that folder.

In some cases, when the progress bar 504 is selected, the folder activity user interface may be presented or an upload progress pop-up window 506 may be presented. The upload progress pop-up window 506 may show a condensed version of the folder activity user interface pertaining to the respective folder. For example, if a folder is selected, the upload progress pop-up window 506 may show a list of content items in the selected folder and how long until those content items are available. In some cases, right clicking the content item or folder or selecting an ellipse symbol may provide an option in a drop-down menu to subscribe to the folder activity user interface of the respective content item or folder.

In some cases, a desktop instance of the client application on a client device may present a pop-up window when a UI window manager of an operating system of the client device indicates that a file explorer of the operating system is ‘in focus’ and the file explorer is showing path to the shared folder. The one or more currently uploading content items being uploaded to the at least one shared folder may take greater than a threshold amount of time to upload. The input requesting the client application to present the folder activity user interface may be received in the pop-up window.

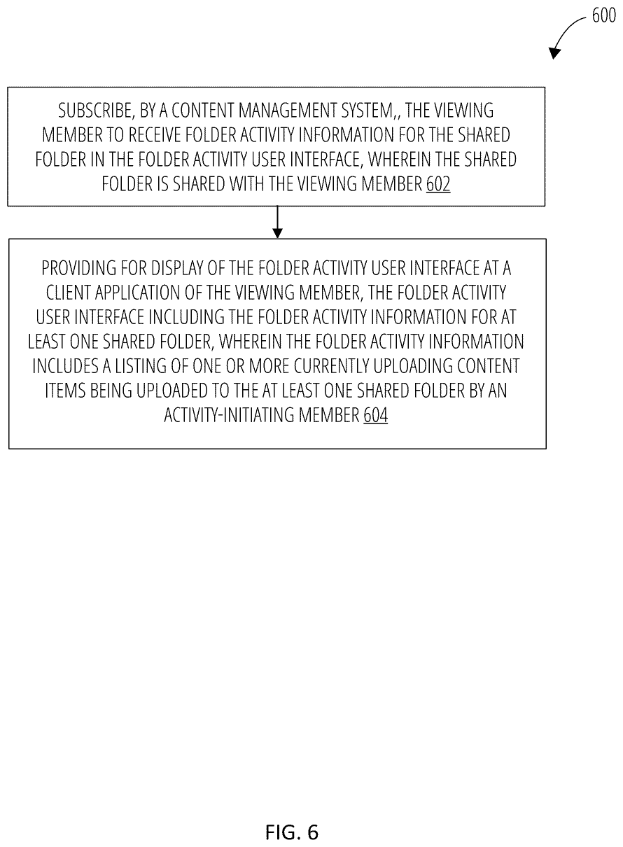

FIG. 6 illustrates an example method of providing a folder activity user interface to a viewing member of a shared folder, wherein the viewing member is different than an activity-initiating member that causes the folder activity, in accordance with some aspects of the present technology. Although example method 600 depicts a particular sequence of operations, the sequence may be altered without departing from the scope of the present disclosure. For example, some of the operations depicted may be performed in parallel or in a different sequence that does not materially affect the function of method 600. In other examples, different components of an example device or system that implements the method 600 may perform functions at substantially the same time or in a specific sequence.

A folder activity user interface, such as a folder activity dashboard as shown in FIG. 3, may provide viewing members an overview of sync progresses of activities by activity-initiating members other than the viewing member, such as uploads by other members to shared folders that the viewing members have access to.

Additionally, the folder activity user interface may include status indicators that correspond to the progress related to folder activity information and the respective currently uploading content items of the shared folder, such as indicating progress towards a time when a respective content item will be accessible to the viewing member. As such, the folder activity user interface may assist viewing members in determining when they can expect large operations, such as bulk uploads, to be completed, which can help them plan their days more efficiently. In some cases, the viewing members may subscribe to folder activity information by a sharing service, and receive a notification when a given upload has completed, as an example.

According to some examples, the method 600 includes subscribing, by a content management system, a viewing member to receive folder activity information for a shared folder in a folder activity user interface at step 602. The shared folder may be shared with the viewing member. In some cases, client application 136 or content management system 102 may subscribe the viewing member to receive the folder activity information.

According to some examples, the method 600 includes providing for display the folder activity user interface at a client application of the viewing member at step 604. The folder activity user interface may include the folder activity information for at least one shared folder. The folder activity information may include a listing of one or more content items being uploaded to the at least one shared folder by an activity-initiating member. The viewing member may be different than the activity-initiating member. In some cases, client application 136 may present the folder activity user interface.

More specifically, the sharing service may receive an estimated time that a particular content item would be uploaded by the content management system from an uploading instance of a client application. The client application may be a web browser or a client synchronization service. The sharing service may provide the estimated time to the content management system. In some cases, the status indicator may combine the estimated time that the content item would be uploaded to the content management system with an estimated time that the content item would be stored by a content item storage service and is accessible at the client application.

A selection of a sync priority user interface control, presented in the folder activity user interface, may be received and may be effective to request that the activity-initiating member instance of the client application prioritize uploading a particular content item associated with the sync priority user interface control. For example, one particular content item of a batch of content items that are being uploaded may need to be prioritized. As such, the selection of a sync priority user interface control associated with the particular content item may prioritize the synchronization of that content item. Additionally, the prioritization may effectively mean prioritizing syncing of at least metadata for a branch of a file tree, causing the client synchronization service to be less efficient by prioritizing the particular content item, or synchronize the particular content item down first even if the location is not correct and the content item can be moved after syncing is completed.

In some cases, the viewing member may be automatically subscribed to receive folder activity information for all shared folders to which the viewing member has access. Additionally, the sharing service may determine to automatically subscribe the viewing member to receive the shared folder activity information for the shared folder in the folder activity user interface. The content management system may automatically subscribe the viewing member to receive the shared folder activity information for the shared folder in the folder activity user interface, and cause the viewing member to be subscribed to the shared folder activity information temporarily. In some cases, the viewing member may become unsubscribed after the shared folder has completed synchronization for the viewing member, or become unsubscribed after a pre-determined period.

The determination to automatically subscribe may account for whether the viewing member is active in the shared folder, wherein the viewing member is determined to be active in the shared folder when they access a content item in the shared folder more often a predetermined metric. The predetermined metric can be that they access the content item more often than (e.g., once a month, once a week, twice a week, every day, multiple times a day . . . ). The determination to automatically subscribe may account for whether the viewing member created the shared folder, and/or whether the content items being uploaded will take greater than a threshold amount of time to upload (e.g., the one or more content items will take more than 5 seconds, 15 seconds, 30 seconds, 1 minute, etc.).

In some cases, the sharing service may receive a request from the activity-initiating member to subscribe the viewing member to the shared folder activity information for the shared folder. The request from the activity-initiating member to subscribe the viewing member to the shared folder activity information may be received in a sharing modal in which the activity-initiating member shares the shared folder with the viewing member. The sharing modal may provide other types of sharing notifications as well. The request from the activity-initiating member to subscribe the viewing member to the shared folder activity information in a prompt provided to the activity-initiating member instance of the client application when the activity-initiating member adds a large number of content items to the shared folder, or adds a large content item to the shared folder. The prompt may ask the activity-initiating member if they want to subscribe the viewing member to the shared folder activity information.

In some cases, a web browser instance of the client application may present a pop-up window when the viewing member is viewing a content item in the shared folder or viewing a listing of contents under the shared folder in the web browser instance of the client application. The content items being uploaded may take greater than a threshold amount of time to upload (e.g., the one or more content items will take more than 5 seconds, 15 seconds, 30 seconds, 1 minute, etc.). An input requesting the client application to present the folder activity user interface may be received, and the input may request the client application to present the folder activity user interface is received in the pop-up window.

In some cases, the web browser instance of the client application may present a file explorer interface showing a folder hierarchy for the viewing member account with a status indicator showing upload activity in the at least one shared folder, wherein the input requesting the client application to present the folder activity user interface is received through a selection of the status indicator.

In some cases, a desktop instance of the client application on a client device may present a file explorer showing a path to the shared folder and a progress bar indicating the estimated time remaining for currently uploading content items in the shared folder. Selecting the progress bar may reveal additional information (such as in a pop-up window) about the sync status, such as a list of items in the selected folder and the remaining time required for upload. The content items being uploaded may take greater than a threshold amount of time to upload (e.g., the one or more content items will take more than 5 seconds, 15 seconds, 30 seconds, 1 minute, etc.). The input requesting the client application to present the folder activity user interface may be received in the pop-up window.

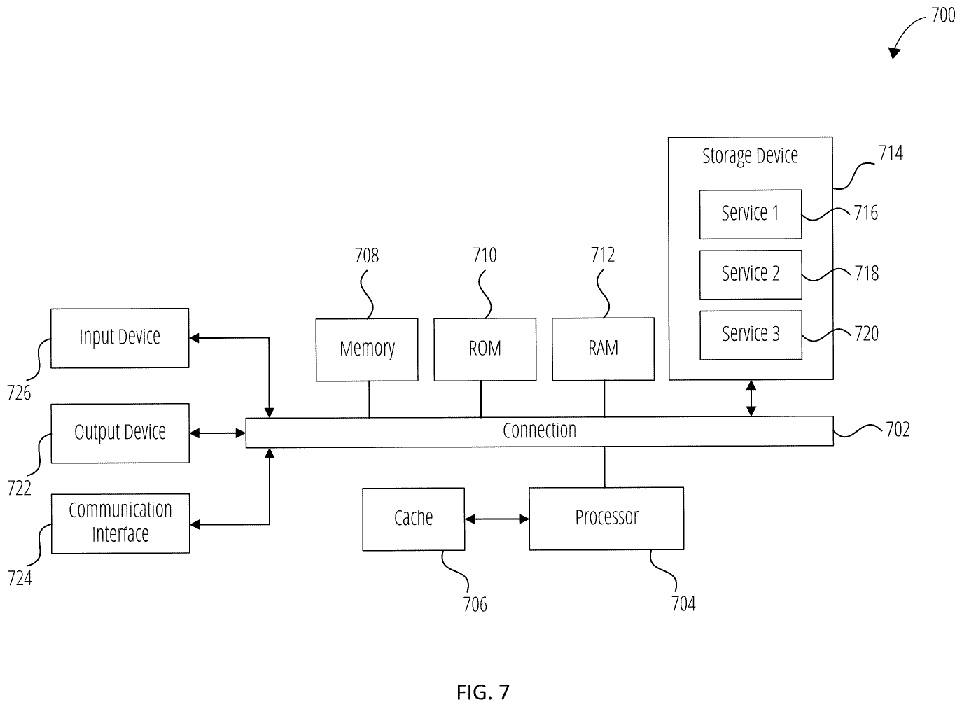

FIG. 7 shows an example of computing system 700, which can be for example any computing device making up content management system 102 or client devices 134, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 708 connected directly with, in close proximity to, or integrated as part of processor 704.

Processor 704 can include any general purpose processor and a hardware service or software service, such as services 706, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

1. A method of providing a folder activity user interface to a viewing member of a shared folder, wherein the viewing member is different than an activity-initiating member that causes a folder activity, the method comprising:
subscribing, at a content management system, the viewing member to receive folder activity information for the shared folder in the folder activity user interface, wherein the shared folder is shared with the viewing member by the activity-initiating member;
providing to a client application at a client device of the viewing member, the folder activity user interface for display, the folder activity user interface including the folder activity information for at least one shared folder, wherein the folder activity information includes a listing of one or more currently uploading content items being uploaded to the at least one shared folder by the activity-initiating member and an estimated time for the one or more currently uploading content items to be accessible at the client application; and
after the currently uploading content items are accessible at the client application, sending the content items to the client application.

2. The method of claim 1, wherein the folder activity user interface includes a status indicator for at least a first content item of the one or more currently uploading content items, the status indicator indicating progress towards a time when the first content item will be accessible to the viewing member.

3. The method of claim 2, further comprising:
determining, by the content management system, an estimated time for the first content item to be uploaded to the content management system from an uploading instance of the client application; and
providing the estimated time for the first content item to be uploaded to the content management system to the client application.

4. The method of claim 3, wherein the status indicator represents at least one of the estimated time for the first content item to be uploaded to the content management system, an estimated time for the first content item to be stored by the content management system and is accessible at the client application, and an estimated time for the first content item to be downloaded by a desktop instance of the client application of the viewing member.

5. The method of claim 1, further comprising:
receiving an indication of a selection of a sync priority user interface control presented in the folder activity user interface; and
in response to receiving the indication, causing an activity-initiating member instance of the client application to prioritize uploading a particular content item from the one or more currently uploading content items.

6. The method of claim 1, further comprising:
receiving, by the content management system, a request from the viewing member to include the folder activity information for the shared folder in the folder activity user interface.

7. The method of claim 1, further comprising:
determining, by the content management system, based at least on a heuristic or a machine learning model, to automatically subscribe the viewing member to receive the folder activity information for the shared folder in the folder activity user interface.

8. The method of claim 7, wherein the determining is in response to at least one of a following determinations:
a determination that the viewing member is active in the shared folder, wherein the viewing member is determined to be active in the shared folder when they access a content item in the shared folder more often a predetermined metric;
a determination that the viewing member created the shared folder; or
a determination that the one or more currently uploading content items being uploaded to the at least one shared folder will take greater than a threshold amount of time to upload.

9. The method of claim 1, further comprising:
receiving, by the content management system, a request from the activity-initiating member to subscribe the viewing member to the folder activity information for the shared folder.

10. The method of claim 9, wherein the request from the activity-initiating member to subscribe the viewing member to the folder activity information is received in a sharing modal in which the activity-initiating member shares the shared folder with the viewing member.

11. The method of claim 9, wherein the request from the activity-initiating member to subscribe the viewing member to the folder activity information is provided in a prompt to the activity-initiating member by their instance of the client application when the activity-initiating member adds a number of content items to the shared folder over a threshold limit, or adds a content item to the shared folder with a size over another threshold limit, wherein the prompt comprises an element selectable by the viewing member to approve subscribing to the folder activity information.

12. The method of claim 1, further comprising:
automatically subscribing the viewing member to receive the folder activity information for all shared folders to which the viewing member has access.

13. The method of claim 1, further comprising:
receiving an input requesting the client application to present the folder activity user interface.

14. The method of claim 13, further comprising:
providing to the client application, for display, a pop-up window when the viewing member is viewing a content item in the shared folder or viewing a listing of contents under the shared folder, and the one or more currently uploading content items being uploaded to the at least one shared folder will take greater than a threshold amount of time to upload.

15. The method of claim 13, further comprising:
providing, to the client application, for display, a folder hierarchy for the viewing member with a status indicator showing upload activity in the at least one shared folder in a file explorer interface, wherein the input requesting the client application to present the folder activity user interface is received through a selection of the status indicator.

16. The method of claim 13, further comprising:
providing, to the client application, for display, a pop-up window when a UI window manager of an operating system of a client device indicates that a file explorer of the operating system is ‘in focus’ and the file explorer is showing path to the shared folder.

17. A non-transitory computer-readable medium including one or more sequences of instructions that, when executed by one or more processors, causes the one or more processors to perform operations comprising:
subscribing a viewing member to receive folder activity information for a shared folder in a folder activity user interface, wherein the shared folder is shared with the viewing member by the activity-initiating member;
providing to a client application on a client device associated with the viewing member, for display, the folder activity user interface including the folder activity information for at least one shared folder-, wherein the folder activity information includes a listing of one or more currently uploading content items being uploaded to the at least one shared folder by an activity-initiating member, wherein the viewing member is different than the activity-initiating member and an estimated time for the one or more currently uploading content items to be accessible at the client application; and
after the currently uploading content items are accessible at the client application, sending the content items to the client application.

18. The non-transitory computer-readable medium of claim 17, wherein the folder activity user interface includes a status indicator for at least a first content item of the one or more currently uploading content items, the status indicator indicating progress towards a time when the first content item will be accessible to the viewing member.

19. The non-transitory computer-readable medium of claim 18, wherein the one or more processors are further caused to perform the operations comprising:
receiving an estimated time for the first content item to be uploaded to a content management system from an uploading instance of a client application; and
providing the estimated time for the first content item to be uploaded to the content management system to the client application for inclusion in the folder activity user interface.

20. A content management system comprising:
one or more processors; and
a non-transitory computer-readable medium including one or more sequences of instructions that, when executed by the one or more processors, causes the one or more processors to perform operations comprising:
automatically subscribing a viewing member to receive a folder activity information for all shared folders to which the viewing member has access;
subscribing the viewing member to receive the folder activity information for a shared folder in a folder activity user interface, wherein the shared folder is shared with the viewing member, wherein the folder activity user interface includes a status indicator for the at least a first content item of the one or more content items indicating progress towards when the first content item will be accessible to the viewing member at a client application on a client device associated with the viewing member;
providing to a client application of the viewing member, for display, the folder activity user interface, the folder activity user interface including the folder activity information for at least one shared folder, wherein the folder activity information includes a listing of one or more currently uploading content items being uploaded to the at least one shared folder by an activity-initiating member, wherein the viewing member is different than the activity-initiating member and an estimated time for the one or more currently uploading content items to be accessible at the client application; and
after the currently uploading content items are accessible at the client application. sending the content items to the client application.
